(19) United States
(12) Patent Application Publication
(10) Pub. No.: US 2026/0200107 A1
(43) Pub. Date: Jul. 16, 2026

(54) GRIPPING EQUIPMENT

(71) Applicant: NANYA TECHNOLOGY CORPORATION, New Taipei City (TW)

(72) Inventors: Chi Ming PAN, New Taipei City (TW); Po-Hsien CHEN, New Taipei City (TW); Kuang Yu CHOU, New Taipei City (TW); Zheng-Xun YANG, New Taipei City (TW)

(21) Appl. No.: 19/023,222

(22) Filed: Jan. 15, 2025

(51) Int. Cl. B25J 19/00; B25J 5/02; B25J 19/02; H02J 7/00

(52) U.S. Cl. CPC B25J 19/005; B25J 5/02; B25J 19/021; H02J 7/70

(57) ABSTRACT

A gripping equipment includes a moving module, a gripping module and a driving device. The moving module includes a moving body, a first charging portion and a power supply. The first charging portion and the power supply are disposed on the moving body configured to move along a rail. The power supply electrically connects with the first charging portion. The gripping module includes a gripping body, a rechargeable battery and a second charging portion. The rechargeable battery and the second charging portion are disposed on the gripping body configured to grip an object. The second charging portion electrically connects with the rechargeable battery and aligns with the first charging portion. The driving device is configured to move the gripping module relative to the moving module, such that the second charging portion is moved to electrically connect with or away from the first charging portion.

### BACKGROUND

### Technical Field

The present disclosure relates to gripping equipment especially used on an overhead hoist transport (OHT) to grip and transfer a front opening unified pod (FOUP).

### Description of Related Art

Since the living standards have been rising nowadays, electronic products are becoming more and more important in our daily lives. Facing to the huge market of electronic products, various manufacturers are working hard to enhance the market competitiveness of their brands.

In fact, apart from strengthening research and development on the functions and performances of electronic products, how to effectively improve the operational efficiency in the production process of electronic products, thereby reducing the production costs of electronic products, is undoubtedly an important issue that various manufacturers highly concern.

### SUMMARY

A technical aspect of the present disclosure is to provide a gripping equipment, which can effectively simplify the structure of the wire(s) connected between the moving module and the gripping module, thus increasing the working life of the wire(s).

According to an embodiment of the present disclosure, a gripping equipment includes a moving module, a gripping module and a driving device. The moving module includes a moving body, a first charging portion and a power supply. The moving body is configured to move along a rail. The first charging portion is disposed on the moving body. The power supply is disposed on the moving body and electrically connected with the first charging portion. The gripping module includes a gripping body, a rechargeable battery and a second charging portion. The gripping body is configured to grip an object. The rechargeable battery is disposed in the gripping body. The second charging portion is disposed on the gripping body and electrically connected with the rechargeable battery. The second charging portion is aligned with the first charging portion. The driving device is disposed on the moving body and connected with the gripping body. The driving device is configured to move the gripping module relative to the moving module, such that the second charging portion is moved to electrically connect with or away from the first charging portion.

In one or more embodiments of the present disclosure, the first charging portion and the second charging portion are respectively a wireless charging coil.

In one or more embodiments of the present disclosure, one of the first charging portion and the second charging portion has at least one plug, while another one of the first charging portion and the second charging portion has at least one socket. The socket is configured to be connected with the plug.

In one or more embodiments of the present disclosure, a corresponding one of the first charging portion and the second charging portion further has at least one elastic element. The elastic element is connected between the plug and a corresponding one of the moving body and the gripping body.

In one or more embodiments of the present disclosure, the first charging portion is configured to mechanically connect with the second charging portion.

In one or more embodiments of the present disclosure, the moving module includes a first wireless communicating device. The first wireless communicating device is disposed on the moving body. The gripping module includes a second wireless communicating device. The second wireless communicating device is disposed on the gripping body. The second wireless communicating device is signally connected with the first wireless communicating device.

In one or more embodiments of the present disclosure, the first wireless communicating device is electrically connected with the power supply, while the second wireless communicating device is electrically connected with the rechargeable battery.

In one or more embodiments of the present disclosure, one of the moving module and the gripping module includes a reflector, while another one of the moving module and the gripping module includes a sensor. The sensor is aligned with the reflector. The sensor is configured to emit a signal towards the reflector and receive a reflected signal from the reflector.

In one or more embodiments of the present disclosure, when the moving module includes the sensor, the sensor is disposed on the moving body and electrically connected with the power supply. The reflector is disposed on the gripping body.

In one or more embodiments of the present disclosure, when the gripping module includes the sensor, the sensor is disposed on the gripping body and electrically connected with the rechargeable battery. The reflector is disposed on the moving body.

In one or more embodiments of the present disclosure, the moving module further includes an image capturing device. The image capturing device is disposed on the moving body and electrically connected with the power supply. The gripping module further includes a logic unit and a plurality of light sources. The light sources and the logic unit are disposed on the gripping body and electrically connected with the rechargeable battery. The logic unit is signally connected with the light sources. The light sources are aligned with the image capturing device. The image capturing device is configured to capture an image of the light sources.

In one or more embodiments of the present disclosure, the gripping body includes a supporting piece and a pair of extendable pieces. The supporting piece is connected with the driving device. The rechargeable battery and the second charging portion are disposed on the supporting piece. The extendable pieces are connected with the supporting piece. The extendable pieces are spaced apart from each other and are configured to at least partially move towards each other to grip the object or away from each other to release the object.

In one or more embodiments of the present disclosure, the driving device includes a plurality of winches. Each of the winches includes a winch body and a wire. The winch body is disposed on the moving body. The wire is wound around the winch body with an end connected with the gripping body.

According to another embodiment of the present disclosure, a gripping equipment includes a moving module, a gripping module and a driving device. The moving module includes a moving body, a first charging portion, a sensor, an image capturing device and a power supply. The moving body is configured to move along a rail. The first charging portion is disposed on the moving body. The power supply is disposed on the moving body and electrically connected with the first charging portion, the sensor and the image capturing device. The gripping module includes a gripping body, a second charging portion, a reflector, a plurality of light sources, a logic unit and a rechargeable battery. The gripping body is configured to grip an object. The second charging portion is disposed on the gripping body and aligned with the first charging portion. The reflector is disposed on the gripping body and aligned with the sensor. The light sources are disposed on the gripping body and aligned with the image capturing device. The logic unit is signally connected with the light sources. The rechargeable battery is disposed in the gripping body and electrically connected with the second charging portion, the light sources and the logic unit. The driving device is disposed on the moving body and connected with the gripping body. The driving device is configured to move the gripping module relative to the moving module, such that the second charging portion is moved to electrically connect with or away from the first charging portion.

In one or more embodiments of the present disclosure, the first charging portion and the second charging portion are respectively a wireless charging coil.

In one or more embodiments of the present disclosure, one of the first charging portion and the second charging portion has at least one plug and at least one elastic element connected between the plug and the said one of the first charging portion and the second charging portion, while another one of the first charging portion and the second charging portion has at least one socket configured to be connected with the plug.

In one or more embodiments of the present disclosure, the first charging portion is configured to mechanically connect with the second charging portion.

In one or more embodiments of the present disclosure, the moving module includes a first wireless communicating device. The first wireless communicating device is disposed on the moving body and electrically connected with the power supply. The gripping module includes a second wireless communicating device. The second wireless communicating device is disposed on the gripping body and electrically connected with the rechargeable battery. The second wireless communicating device is signally connected with the first wireless communicating device.

The above-mentioned embodiments of the present disclosure have at least the following advantages:
(1) By the electrical connection between the first charging portion and the second charging portion, the rechargeable battery of the gripping module can be electrically charged up from the power supply of the moving module. In other words, the supply of power from the power supply of the moving module to the rechargeable battery of the gripping module is independent of the driving device connected therebetween, which means the driving device is not involved in the supply of power from the power supply to the rechargeable battery. Therefore, no conductive element will be disposed in the wire(s) for supplying power from the power supply to the rechargeable battery, which can effectively simplify the structure of the wire(s) and thus increase the working life of the wire(s).
(2) Since the second wireless communicating device of the gripping module is signally connected with the first wireless communicating device of the moving module, the signal connection between the moving module and the gripping module is independent of the driving device, which means the driving device is not involved in the signal connection between the moving module and the gripping module. Therefore, no signal transmitting element will be disposed in the wire(s) for signal connection between the moving module and the gripping module, which can effectively simplify the structure of the wire(s) and thus increase the working life of the wire(s).

### BRIEF DESCRIPTION OF THE DRAWINGS

The disclosure can be more fully understood by reading the following detailed description of the embodiments, with reference made to the accompanying drawings as follows:

FIG. 1 is a front side view of a gripping equipment according to an embodiment of the present disclosure;

FIG. 2 is a sectional view along a sectional line A-A of FIG. 1;

FIG. 3 is a sectional view along a sectional line B-B of FIG. 1;

FIG. 4 is a front side view of a gripping equipment according to another embodiment of the present disclosure;

FIG. 5 is a regionally enlarged view of the first charging portion and the second charging portion of FIG. 4 when connected;

FIG. 6 is a front side view of a gripping equipment according to a further embodiment of the present disclosure;

FIG. 7 is a front side view of a gripping equipment according to another embodiment of the present disclosure;

FIG. 8 is a front side view of a gripping equipment according to a further embodiment of the present disclosure; and

FIG. 9 is a front side view of a gripping equipment according to another embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

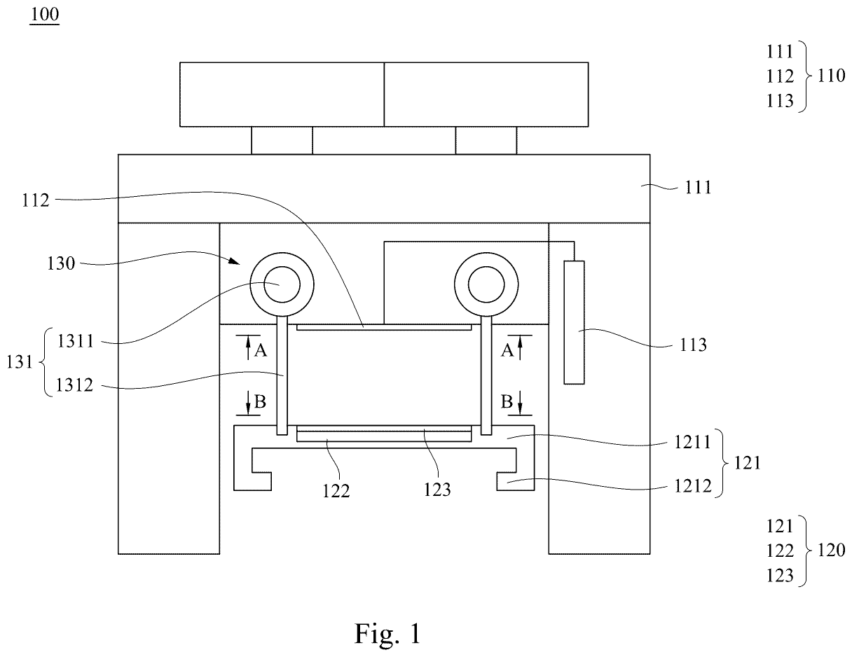

Reference is made to FIG. 1. FIG. 1 is a front side view of a gripping equipment 100 according to an embodiment of the present disclosure. In this embodiment, as shown in FIG. 1, a gripping equipment 100 includes a moving module 110, a gripping module 120 and a driving device 130. The moving module 110 includes a moving body 111, a first charging portion 112 and a power supply 113. The moving body 111 is configured to move along a rail (not shown). The first charging portion 112 is disposed on the moving body 111. The power supply 113 is disposed on the moving body 111 and electrically connected with the first charging portion 112. The gripping module 120 includes a gripping body 121, a rechargeable battery 122 and a second charging portion 123. The gripping body 121 is configured to grip an object (not shown), in which the object is practically a front opening unified pod (FOUP). The rechargeable battery 122 is disposed in the gripping body 121. The second charging portion 123 is disposed on the gripping body 121 and electrically connected with the rechargeable battery 122. The second charging portion 123 is substantially and vertically aligned with the first charging portion 112. The driving device 130 is disposed on the moving body 111 and connected with the gripping body 121. The driving device 130 is configured to move the gripping module 120 relative to the moving module 110, such that the second charging portion 123 is moved to electrically connect with or away from the first charging portion 112.

In practical applications, as shown in FIG. 1, the driving device 130 includes a plurality of winches 131. Each of the winches 131 includes a winch body 1311 and a wire 1312. The winch body 1311 is disposed on the moving body 111. The wire 1312 is wound around the winch body 1311 with an end connected with the gripping body 121. By a rotational action of the winch body 1311 of each of the winches 131, the gripping module 120 can be lifted up or lowered down relative to the moving module 110 by the wire 1312 of each of the winches 131.

It is worth to note that, by the electrical connection between the first charging portion 112 and the second charging portion 123, the rechargeable battery 122 of the gripping module 120 can be electrically charged up by the power supply 113 of the moving module 110. In other words, the supply of power from the power supply 113 of the moving module 110 to the rechargeable battery 122 of the gripping module 120 is independent of the driving device 130 connected therebetween, which means the driving device 130 is not involved in the supply of power from the power supply 113 to the rechargeable battery 122. Therefore, no conductive element will be disposed in the wire(s) 1312 for supplying power from the power supply 113 to the rechargeable battery 122, which can effectively simplify the structure of the wire(s) 1312 and thus increase the working life of the wire(s) 1312.

Moreover, as shown in FIG. 1, the gripping body 121 includes a supporting piece 1211 and a pair of extendable pieces 1212. The supporting piece 1211 is connected with the wire(s) 1312 of the driving device 130. The rechargeable battery 122 and the second charging portion 123 are disposed on the supporting piece 1211. The extendable pieces 1212 are connected with the supporting piece 1211. The extendable pieces 1212 are spaced apart from each other and are configured to at least partially move towards each other to grip the object or away from each other to release the object.

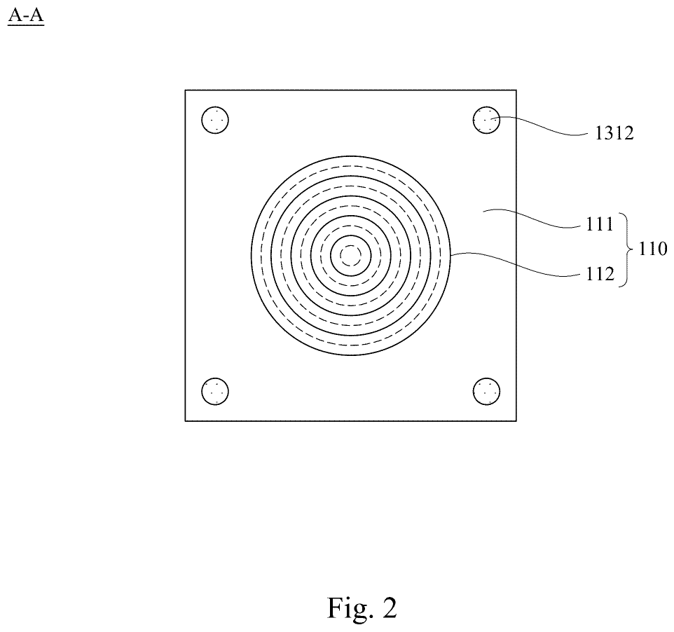

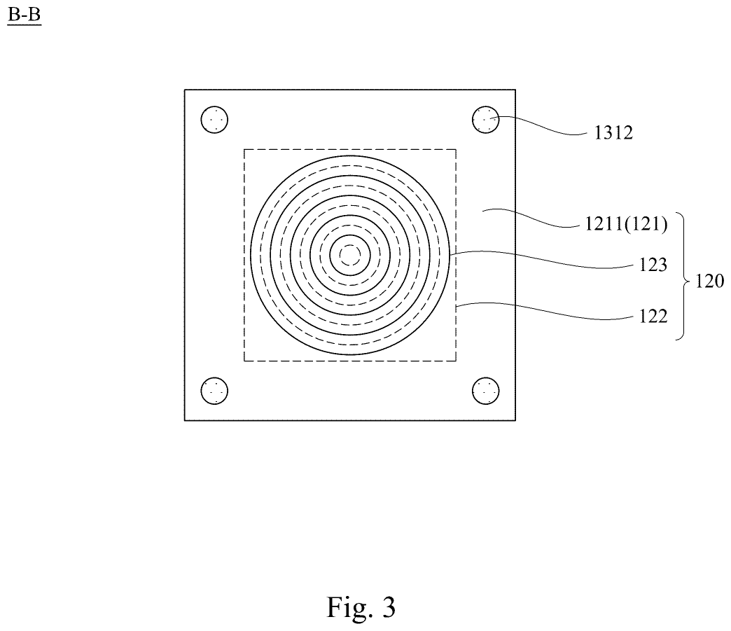

Reference is made to FIGS. 2-3. FIG. 2 is a sectional view along a sectional line A-A of FIG. 1. FIG. 3 is a sectional view along a sectional line B-B of FIG. 1. In this embodiment, as shown in FIGS. 2-3, the first charging portion 112 and the second charging portion 123 are respectively a wireless charging coil. This means, the electrical connection between the first charging portion 112 and the second charging portion 123 can be formed without direct contact of each other.

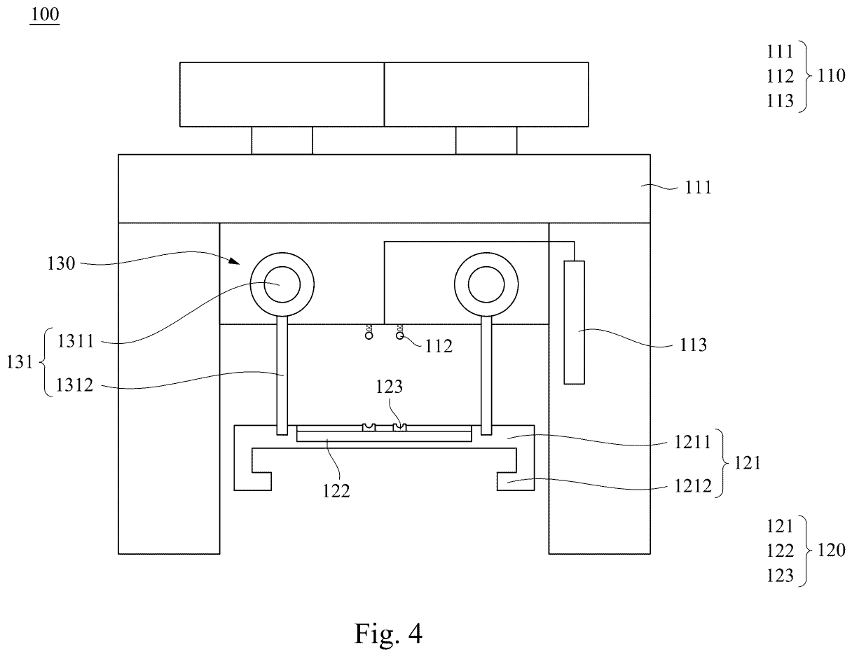

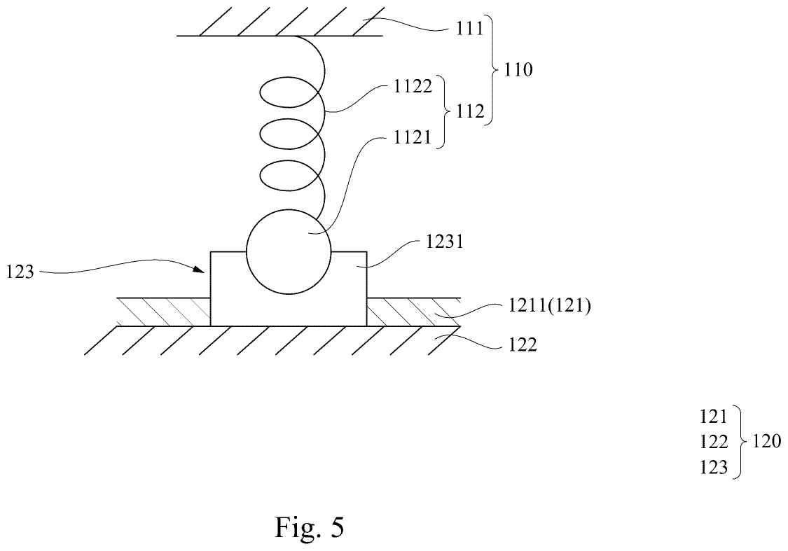

Reference is made to FIGS. 4-5. FIG. 4 is a front side view of a gripping equipment 100 according to another embodiment of the present disclosure. FIG. 5 is a regionally enlarged view of the first charging portion 112 and the second charging portion 123 of FIG. 4 when connected. In this embodiment, one of the first charging portion 112 and the second charging portion 123 has at least one plug, while another one of the first charging portion 112 and the second charging portion 123 has at least one socket. The socket is configured to be connected with the plug. For example, as shown in FIGS. 4-5, the first charging portion 112 has the plug 1121, while the second charging portion 123 has the socket 1231. Moreover, the first charging portion 112 further has at least one elastic element 1122. The elastic element 1122 is connected between the plug 1121 and the moving body 111, such that the elastic element 1122 provides a buffering effect when the plug 1121 is connected with the socket 1231. In practice, the elastic element 1122 can be a spring. In other embodiments, according to the actual situations, the first charging portion 112 has the socket, while the second charging portion 123 has the plug. In this case, the second charging portion 123 further has at least one elastic element connected between the plug and the gripping body 121.

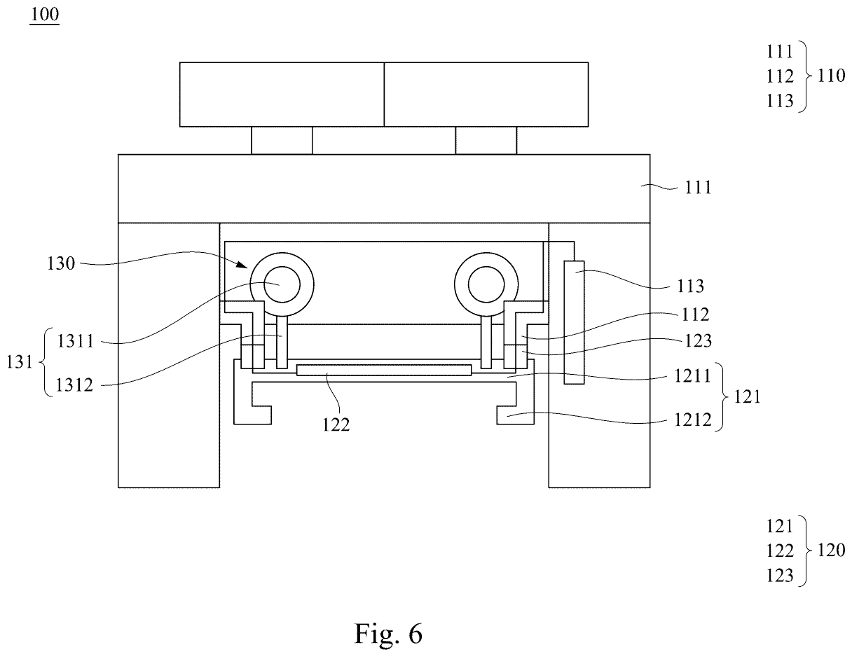

Reference is made to FIG. 6. FIG. 6 is a front side view of a gripping equipment 100 according to a further embodiment of the present disclosure. In this embodiment, the first charging portion 112 and the second charging portion 123 are respectively formed as engaging structures, such that the second charging portion 123 can be mechanically connected or engaged with the first charging portion 112, when the gripping module 120 is moved close to the moving module 110, as shown in FIG. 6. In this way, when the first charging portion 112 and the second charging portion 123 are mechanically connected with each other to hold the gripping module 120 in position relative to the moving module 110, the electrical connection between the first charging portion 112 and the second charging portion 123 is also formed.

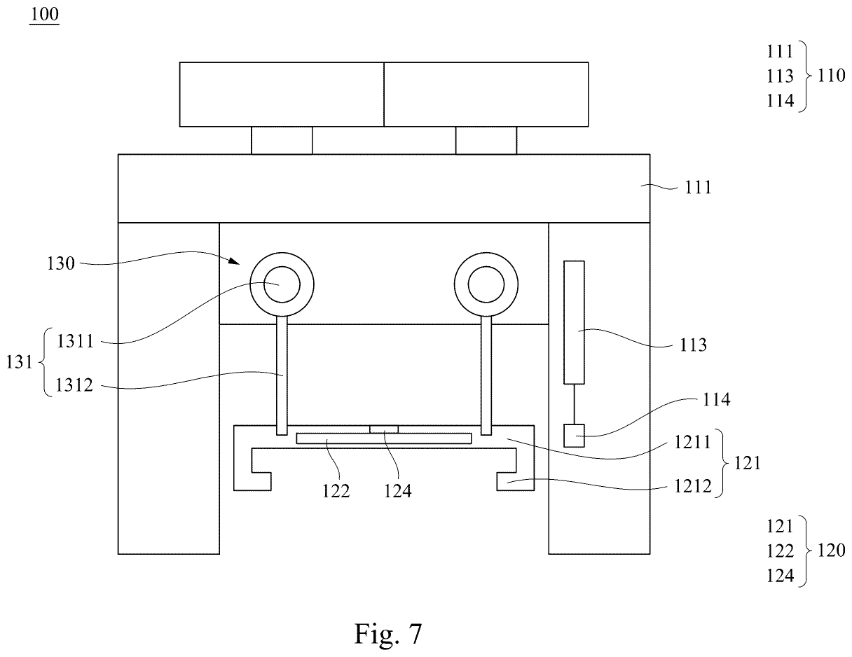

Reference is made to FIG. 7. FIG. 7 is a front side view of a gripping equipment 100 according to another embodiment of the present disclosure. For the sake of drawing simplification, the first charging portion 112 and the second charging portion 123 are omitted in FIG. 7. In this embodiment, as shown in FIG. 7, the moving module 110 includes a first wireless communicating device 114. The first wireless communicating device 114 is disposed on the moving body 111 and electrically connected with the power supply 113. Correspondingly, the gripping module 120 includes a second wireless communicating device 124. The second wireless communicating device 124 is disposed on the supporting piece 1211 of the gripping body 121 and electrically connected with the rechargeable battery 122. The second wireless communicating device 124 of the gripping module 120 is signally connected with the first wireless communicating device 114 of the moving module 110. In other words, the signal connection between the moving module 110 and the gripping module 120 is independent of the driving device 130, which means the driving device 130 is not involved in the signal connection between the moving module 110 and the gripping module 120. Therefore, no signal transmitting element will be disposed in the wire(s) 1312 for signal connection between the moving module 110 and the gripping module 120, which can effectively simplify the structure of the wire(s) 1312 and thus increase the working life of the wire(s) 1312.

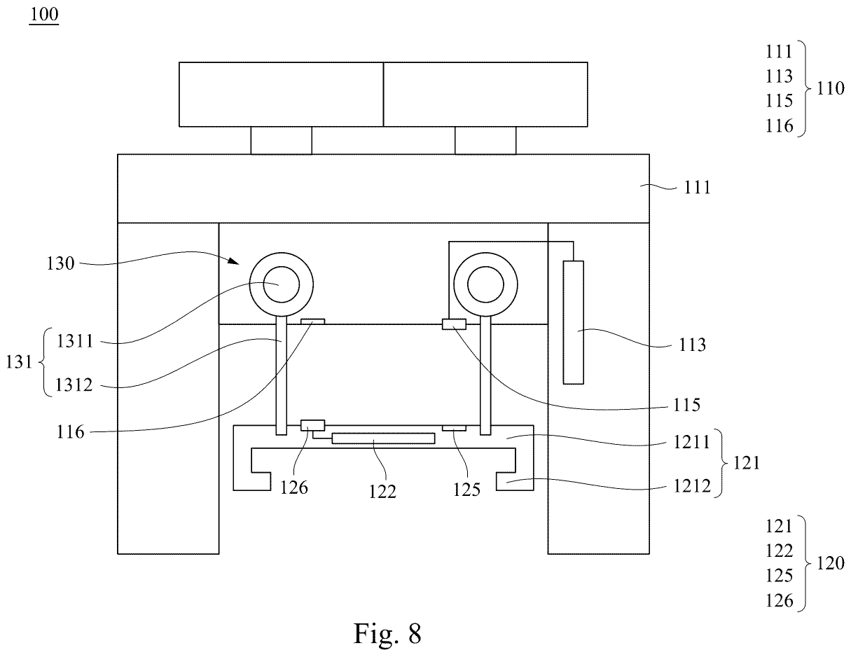

Reference is made to FIG. 8. FIG. 8 is a front side view of a gripping equipment 100 according to a further embodiment of the present disclosure. For the sake of drawing simplification, the first charging portion 112 and the second charging portion 123 are omitted in FIG. 8. In this embodiment, one of the moving module 110 and the gripping module 120 includes a reflector, while another one of the moving module 110 and the gripping module 120 includes a sensor. The sensor is substantially and vertically aligned with the reflector. The sensor is configured to emit a signal towards the reflector and receive a reflected signal from the reflector, so as to monitor the horizontal level of the gripping module 120. For example, as shown in FIG. 8, the moving module 110 includes the sensor 115, and the sensor 115 is disposed on the moving body 111 and electrically connected with the power supply 113. Correspondingly, the reflector 125 is disposed on the supporting piece 1211 of the gripping body 121 and aligned with the sensor 115. When the sensor 115 emits a signal towards the reflector 125, the reflector 125 will reflect the signal and the sensor 115 will receive a reflected signal from the reflector 125. However, in case the magnitude of the reflected signal received by the sensor 115 is reduced, or the reflected signal to the sensor 115 is vanished, it can then be concluded that the gripping module 120 is inclined relative to the moving module 110 to a certain extent.

Similarly, as shown in FIG. 8, the gripping module 120 includes the sensor 126, and the sensor 126 is disposed on the supporting piece 1211 of the gripping body 121 and electrically connected with the rechargeable battery 122. Correspondingly, the reflector 116 is disposed on the moving body 111 and aligned with the sensor 126. Similarly, when the sensor 126 emits a signal towards the reflector 116, the reflector 116 will reflect the signal and the sensor 126 will receive a reflected signal from the reflector 116. However, in case the magnitude of the reflected signal received by the sensor 126 is reduced, or the reflected signal to the sensor 126 is vanished, it can then be concluded that the gripping module 120 is inclined relative to the moving module 110 to a certain extent.

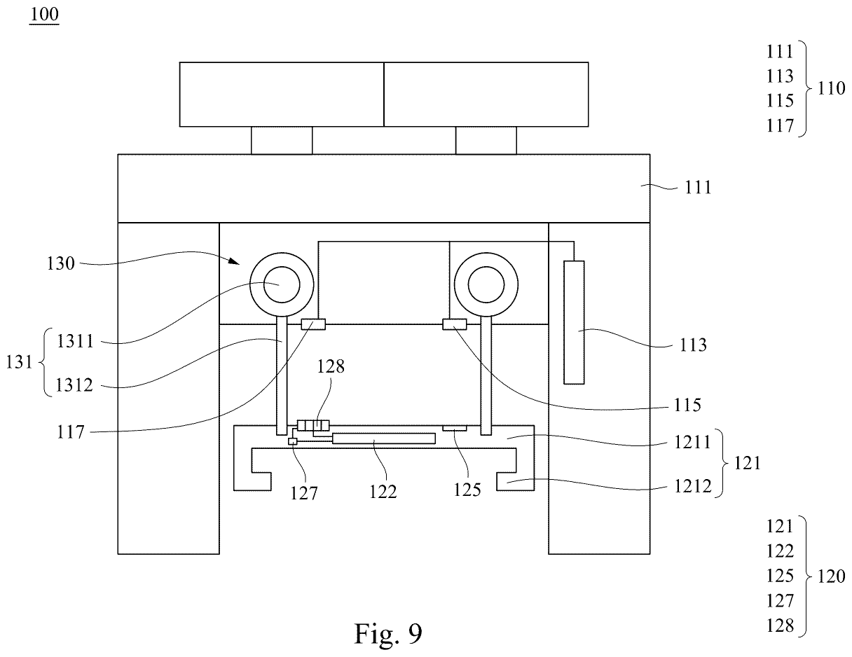

Reference is made to FIG. 9. FIG. 9 is a front side view of a gripping equipment 100 according to another embodiment of the present disclosure. For the sake of drawing simplification, the first charging portion 112 and the second charging portion 123 are omitted in FIG. 9. In this embodiment, as shown in FIG. 9, apart from the sensor 115 as mentioned above, the moving module 110 further includes an image capturing device 117. The image capturing device 117 is disposed on the moving body 111 and electrically connected with the power supply 113. Correspondingly, apart from the reflector 125 as mentioned above, the gripping module 120 further includes a logic unit 127 and a plurality of light sources 128. The light sources 128 and the logic unit 127 are disposed on the supporting piece 1211 of the gripping body 121 and electrically connected with the rechargeable battery 122. The logic unit 127, which can be a microscopic logic unit, is signally connected with the light sources 128. Under different conditions of the gripping module 120, the logic unit 127 controls to light up the light sources 128 differently. In practice, the light sources 128 are of different colors, and the light sources 128 are aligned with the image capturing device 117. The image capturing device 117 is configured to capture an image of the light sources 128, such that the conditions of the gripping module 120 can be monitored through the image capturing device 117.

In conclusion, the aforementioned embodiments of the present disclosure have at least the following advantages:
(1) By the electrical connection between the first charging portion and the second charging portion, the rechargeable battery of the gripping module can be electrically charged up from the power supply of the moving module. In other words, the supply of power from the power supply of the moving module to the rechargeable battery of the gripping module is independent of the driving device connected therebetween, which means the driving device is not involved in the supply of power from the power supply to the rechargeable battery. Therefore, no conductive element will be disposed in the wire(s) for supplying power from the power supply to the rechargeable battery, which can effectively simplify the structure of the wire(s) and thus increase the working life of the wire(s).
(2) Since the second wireless communicating device of the gripping module is signally connected with the first wireless communicating device of the moving module, the signal connection between the moving module and the gripping module is independent of the driving device, which means the driving device is not involved in the signal connection between the moving module and the gripping module. Therefore, no signal transmitting element will be disposed in the wire(s) for signal connection between the moving module and the gripping module, which can effectively simplify the structure of the wire(s) and thus increase the working life of the wire(s).

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A gripping equipment, comprising:
a moving module, comprising:
a moving body configured to move along a rail;
a first charging portion disposed on the moving body; and
a power supply disposed on the moving body and electrically connected with the first charging portion;
a gripping module, comprising:
a gripping body configured to grip an object;
a rechargeable battery disposed in the gripping body; and
a second charging portion disposed on the gripping body and electrically connected with the rechargeable battery, the second charging portion being aligned with the first charging portion; and
a driving device disposed on the moving body and connected with the gripping body, the driving device being configured to move the gripping module relative to the moving module, such that the second charging portion is moved to electrically connect with or away from the first charging portion.

2. The gripping equipment of claim 1, wherein the first charging portion and the second charging portion are respectively a wireless charging coil.

3. The gripping equipment of claim 1, wherein one of the first charging portion and the second charging portion has at least one plug, another one of the first charging portion and the second charging portion has at least one socket configured to be connected with the plug.

4. The gripping equipment of claim 3, wherein a corresponding one of the first charging portion and the second charging portion further has at least one elastic element connected between the plug and a corresponding one of the moving body and the gripping body.

5. The gripping equipment of claim 1, wherein the first charging portion is configured to mechanically connect with the second charging portion.

6. The gripping equipment of claim 1, wherein the moving module comprises:
a first wireless communicating device disposed on the moving body,
the gripping module comprises:
a second wireless communicating device disposed on the gripping body, the second wireless communicating device is signally connected with the first wireless communicating device.

7. The gripping equipment of claim 6, wherein the first wireless communicating device is electrically connected with the power supply, the second wireless communicating device is electrically connected with the rechargeable battery.

8. The gripping equipment of claim 1, wherein one of the moving module and the gripping module comprises a reflector, another one of the moving module and the gripping module comprises a sensor aligned with the reflector, the sensor is configured to emit a signal towards the reflector and receive a reflected signal from the reflector.

9. The gripping equipment of claim 8, wherein when the moving module comprises the sensor, the sensor is disposed on the moving body and electrically connected with the power supply, the reflector is disposed on the gripping body.

10. The gripping equipment of claim 8, wherein when the gripping module comprises the sensor, the sensor is disposed on the gripping body and electrically connected with the rechargeable battery, the reflector is disposed on the moving body.

11. The gripping equipment of claim 1, wherein the moving module further comprises an image capturing device disposed on the moving body and electrically connected with the power supply, the gripping module further comprises a logic unit and a plurality of light sources, the light sources and the logic unit are disposed on the gripping body and electrically connected with the rechargeable battery, the logic unit is signally connected with the light sources, the light sources are aligned with the image capturing device, the image capturing device is configured to capture an image of the light sources.

12. The gripping equipment of claim 1, wherein the gripping body comprises:
a supporting piece connected with the driving device, the rechargeable battery and the second charging portion are disposed on the supporting piece; and
a pair of extendable pieces connected with the supporting piece, the extendable pieces are spaced apart from each other and are configured to at least partially move towards each other to grip the object or away from each other to release the object.

13. The gripping equipment of claim 1, wherein the driving device comprises:
a plurality of winches, each of the winches comprises:
a winch body disposed on the moving body; and
a wire wound around the winch body with an end connected with the gripping body.

14. A gripping equipment, comprising:
a moving module, comprising:
a moving body configured to move along a rail;
a first charging portion disposed on the moving body;
a sensor;
an image capturing device; and
a power supply disposed on the moving body and electrically connected with the first charging portion, the sensor and the image capturing device;
a gripping module, comprising:
a gripping body configured to grip an object;
a second charging portion disposed on the gripping body and aligned with the first charging portion;
a reflector disposed on the gripping body and aligned with the sensor;
a plurality of light sources disposed on the gripping body and aligned with the image capturing device;
a logic unit signally connected with the light sources; and
a rechargeable battery disposed in the gripping body and electrically connected with the second charging portion, the light sources and the logic unit; and
a driving device disposed on the moving body and connected with the gripping body, the driving device being configured to move the gripping module relative to the moving module, such that the second charging portion is moved to electrically connect with or away from the first charging portion.

15. The gripping equipment of claim 14, wherein the first charging portion and the second charging portion are respectively a wireless charging coil.

16. The gripping equipment of claim 14, wherein one of the first charging portion and the second charging portion has at least one plug and at least one elastic element connected between the plug and the said one of the first charging portion and the second charging portion, another one of the first charging portion and the second charging portion has at least one socket configured to be connected with the plug.

17. The gripping equipment of claim 14, wherein the first charging portion is configured to mechanically connect with the second charging portion.

18. The gripping equipment of claim 14, wherein the moving module comprises:
a first wireless communicating device disposed on the moving body and electrically connected with the power supply,
the gripping module comprises:
a second wireless communicating device disposed on the gripping body and electrically connected with the rechargeable battery, the second wireless communicating device is signally connected with the first wireless communicating device.
